(19) United States
(12) Patent Application Publication
(10) Pub. No.: US 2014/0006769 A1
(43) Pub. Date: Jan. 2, 2014

(54) DEVICE OPTIMIZATION MODES

(71) Applicants: Susan Chory, Seattle, WA (US); Zachary Adam Pfriem, Seattle, WA (US); Hagen A. Green, Kirkland, WA (US); William Scott Stauber, Seattle, WA (US); Vishal V. Ghotge, Seattle, WA (US)

(72) Inventors: Susan Chory, Seattle, WA (US); Zachary Adam Pfriem, Seattle, WA (US); Hagen A. Green, Kirkland, WA (US); William Scott Stauber, Seattle, WA (US); Vishal V. Ghotge, Seattle, WA (US)

(21) Appl. No.: 13/536,771

(22) Filed: Jun. 28, 2012

(51) Int. Cl. G06F 1/24

(52) U.S. Cl. 713/100

(57) ABSTRACT

In embodiments of device optimization modes, a device includes data systems that initiate user notifications. The device also includes an activity system that facilitates an activity for user interaction, such as any type of active and/or passive user interaction activities. An optimization controller is implemented to initiate an optimization mode to suppress the user notifications during the activity. The optimization controller can suppress the user notifications from the data systems, and maintain the user notifications until the optimization mode is ended and the user notifications are resumed.

### BACKGROUND

Computing, communication, electronic, and entertainment devices, such as mobile phones, portable computers, tablet devices, and the like increasingly offer more functions, applications, and features. For example, not only can a mobile phone be used for text, email, and voice communications, but may also be used for entertainment, such as to listen to music, browse Internet sites, watch video content, gaming, and for photo and video imaging. Similarly, a portable tablet device may be utilized for email, browser, navigation, and other computing applications, as well as for the various entertainment and photo features. Other types of electronic of devices can also include multiple functions and features, such as a television that can display media content and answer the phone, or an automobile that can provide navigation directions as well as answer the phone. A mobile device, such as a tablet or phone, may also be used for presentations and to stream media content to an external display device, such as a movie that is downloaded to the mobile device and displayed for viewing on a television display device that is coupled to the mobile device. In addition to the many computing, communication, entertainment, and presentation applications that are available to a user with a mobile phone or tablet device, a seemingly unlimited number of third-party applications and features are also available for download to a device.

Many users enjoy the convenience and portability of a single device that facilitates the many functions, applications, communications, and features for both work and social activities. However, there are an increasing number of situations where users want their multi-purpose device to be optimized for a specific use or experience. Some of these situations can occur when a user may want to limit or restrict some or all communications, alerts, and notices, such as to avoid receiving a phone call or having a text message, email notice, calendar event, or other type of notice displayed during a meeting on an external display device or on an integrated display of the mobile device. Some users may remove the SIM card from a mobile phone to stop phone and voice interruptions on the phone. However, this does not stop calendar reminders, to-do alerts, or instant messages if the mobile phone communicates on a wireless network. Some devices may include a presentation mode to restrict display of incoming messages and email alerts during a presentation display, or may include an airplane mode that turns off the device modem to restrict signal transmission during a flight. However, these types of device modes are not configurable by a user and, for example, the airplane mode is simply available to meet flight regulations for electronic devices. A further limitation of conventional device modes is that they require direct user input to enter and exit a device mode.

### SUMMARY

This Summary introduces simplified concepts of device optimization modes, and the concepts are further described below in the Detailed Description and/or shown in the Figures. This Summary should not be considered to describe essential features of the claimed subject matter, nor used to determine or limit the scope of the claimed subject matter.

Device optimization modes are described. In embodiments, a device includes data systems that initiate user notifications, such as a phone call ring, or an audible or display notification of a text message, email message, instant message, calendar event or reminder, geo-location alert, advertisement, weight-loss reminder, gaming notification (e.g., it is the user's turn to play), and any other types of user notifications. The device also includes an activity system, which may include a display device, an audio system, a software application, device hardware, and the like, that facilitates an activity for user interaction, such as watching a movie, viewing photo images, playing a video game, browsing Internet sites, or other types of active and/or passive user interaction activities. An optimization controller is implemented to receive an input to initiate an optimization mode to suppress the user notifications during an activity. The optimization controller can suppress the user notifications from the data systems, and maintain the user notifications until the optimization mode is ended and the user notifications are resumed.

In embodiments, the optimization modes can be user-configured or pre-defined or optimization modes. The optimization controller can receive a user input to initiate an optimization mode, or can receive an automated input from an activity system. The optimization controller can also initiate an optimization mode based on a pre-set time setting, a location of the device, and/or a proximity of the device relative to other devices. The optimization controller can end or cancel an optimization mode when an activity terminates, after a duration of time, or when a user input is received to end the optimization mode. The optimization controller is implemented to initiate a battery level warning of an optimization mode to indicate a minimum level of battery power remaining to power the device over a duration of time, such as for the next hour, or for the remainder of the workday. The minimum level of battery power can be determined based on an average of previous battery power used over similar durations of time.

The optimization controller is also implemented to manage the suppressed user notifications when an optimization mode is ended, and can control an order and pace in which the suppressed user notifications are resumed. In implementations, the optimization controller can initiate one audible tone of a particular format for multiple audible tones of the particular format that are suppressed in the optimization mode. Alternatively or in addition, the optimization controller can replace a collective of the suppressed user notifications with an optimization mode notification when the optimization mode is ended. The optimization controller can also generate a summary of the suppressed user notifications, generate a quick time playback of the suppressed user notifications, and/or organize the suppressed user notifications by time, priority, or a defined preference for user selection. The optimization controller can also be implemented to control optimization responses (e.g., a busy response), such as an automatic text back if a user of a device is driving and cannot text, or initiate playback of a different voice message if the user is in a meeting and cannot take a phone call.

### BRIEF DESCRIPTION OF THE DRAWINGS

Embodiments of device optimization modes are described with reference to the following Figures. The same numbers may be used throughout to reference like features and components that are shown in the Figures:

FIG. 1 illustrates an example device in which embodiments of device optimization modes can be implemented.

FIG. 2 illustrates an example system in which embodiments of device optimization modes can be implemented.

FIG. 3 illustrates example method(s) of device optimization modes in accordance with one or more embodiments.

FIG. 4 illustrates various components of an example device that can implement embodiments of device optimization modes.

### DETAILED DESCRIPTION

Embodiments of device optimization modes are described and may be implemented in any type of device that supports multiple tasks, such as a mobile phone, tablet, computing, communication, entertainment, gaming, navigation, and/or other type of device. In embodiments, various optimization modes can be implemented to eliminate or minimize distractions, as well as to conserve processing resources and battery power. The optimization modes can be pre-defined, selectable optimization modes or user-configured, selectable optimization modes. A user of a device can customize and configure the features and functionality of any type of optimization mode, suited to his or her specific needs and activities.

An electronic and/or computing device includes data systems that initiate user notifications, such as a phone call ring, or an audible or display notification of a text message, email message, instant message, calendar event or reminder, geo-location alert, advertisement, weight-loss reminder, gaming notification (e.g., it is the user's turn to play), and any other types of user notifications. An optimization controller suppresses the user notifications from the data systems based the selected or invoked optimization mode, and the user notifications are maintained until the optimization mode is ended and the user notifications are resumed. The optimization controller also implements a smooth resumption of functionality without loss of data to resume the user notifications, and without overwhelming the user with all of the suppressed user notifications when the optimization mode is ended.

While features and concepts of device optimization modes can be implemented in any number of different devices, systems, networks, environments, and/or configurations, embodiments of device optimization modes are described in the context of the following example devices, systems, and methods.

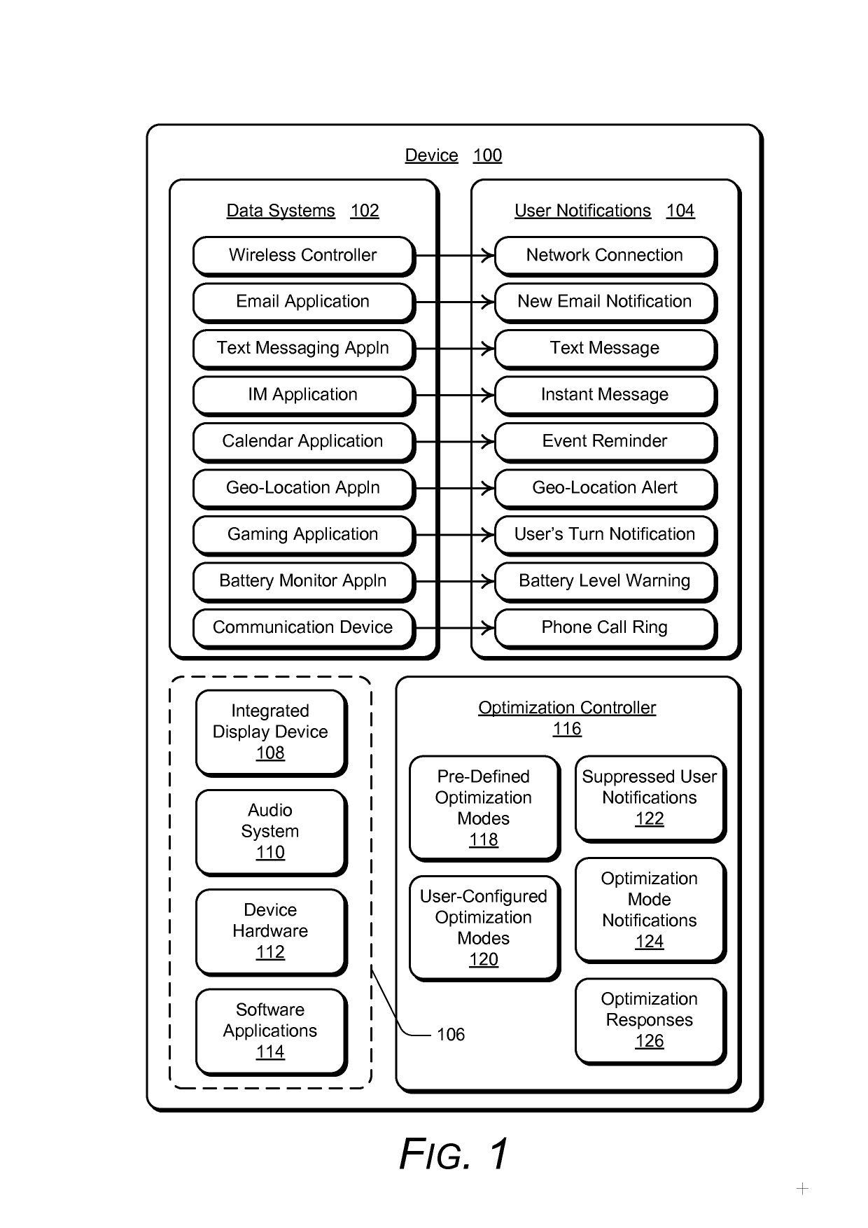

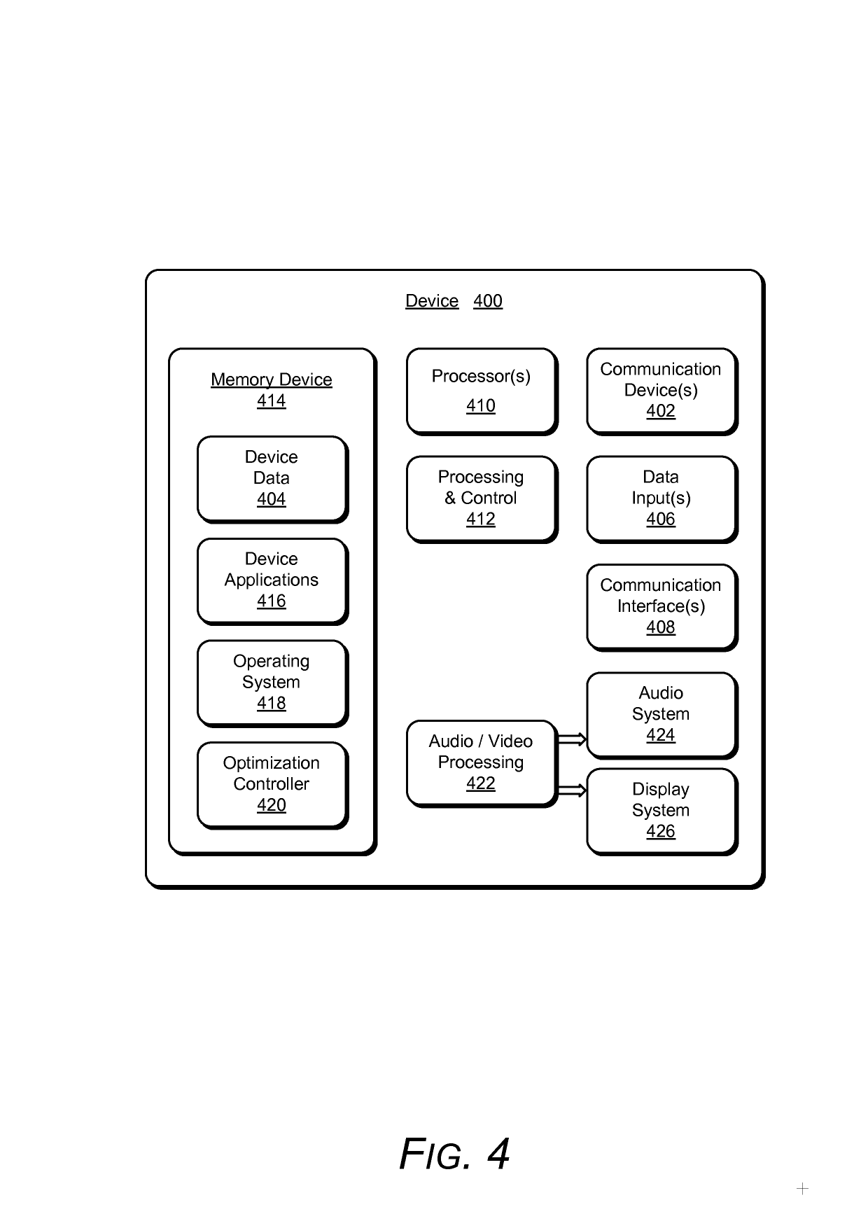

FIG. 1 illustrates an example device 100 in which embodiments of device optimization modes can be implemented. The example device may be any one or combination of a wired or wireless device, such as a mobile phone, tablet, computing, communication, entertainment, gaming, navigation, and/or other type of device. Any of the devices can be implemented with various components, such as a processor and/or memory system, as well as any number and combination of differing components as further described with reference to the example device shown in FIG. 4 to implement embodiments of device optimization modes.

The example device 100 includes any number and different types of data systems 102 that initiate user notifications 104, such as audible alert tones and display notifications. For example, a wireless controller may indicate the availability of a network connection as a pop-up display. Similarly, an email application, text messaging application, or instant messaging application can initiate an audible alert tone and/or display a notification of a new email message, text message, or instant message. A calendar application can also initiate an audible alert tone and/or display a notification of a calendar event, reminder, and/or to-do notification. Similarly, a geo-location application can initiate a geo-location alert. A gaming application can also initiate user notifications, such as a notification that displays to inform a user it is his or her turn to play, such as when playing a game with a networked opponent. A battery monitor application may also be implemented to initiate an audible alert tone and/or display a battery level warning notification.

When implemented as a mobile phone, the data systems 102 of the device 100 can include a communication device that will ring to notify a user of an incoming phone call. The communication device can communicate via communication networks, such as IP-based networks and mobile operator networks that are managed by mobile operators, to include a communication service provider, cell-phone provider, and/or Internet service provider. A mobile operator can facilitate mobile data and/or voice communication for any type of a wireless device or mobile phone.

The example device 100 also includes an activity system 106 that facilitates any type of activities for user interaction with the device, such as watching a movie, viewing photo images, playing a video game, browsing Internet sites, or other types of active and/or passive user interaction activities. The activity system 106 may include an integrated display device 108 (of the device 100) an audio system 110, device hardware 112 (and firmware), as well as any number and combination of differing components as further described with reference to the example device shown in FIG. 4. The activity system 106 can also include software applications 114 (e.g., computer-executable instructions) that can be executed by a processor or processor system to facilitate user interaction with the device, such as a video playback application, image viewer, media content application, video game applications, browser application, and any other type of software applications. Alternatively or in addition, the activity system 106 may also include any type of external devices and/or components, such as a television display device that is coupled to the device to display streaming media, such as a movie or other video content.

In embodiments, the device 100 includes an optimization controller 116 that initiates an optimization mode during an activity on the device. The optimization controller can suppress any one or combination of the user notifications 104 from the data systems 102 based on parameters of the optimization mode, and maintain the user notifications until the optimization mode is ended and the user notifications are resumed. The optimization controller 116 may be implemented as a module or component of the device operating system, or may be implemented at the application layer, such as an independent application that is designed to communicate with the data systems 102 and/or the device operating system.

In embodiments, various optimization modes can be implemented to eliminate or minimize distractions, as well as to optimize use of processing resources and battery power for an optimized user activity experience when using the device 100. In this example, the optimization modes can be pre-defined, selectable optimization modes 118 or user-configured, selectable optimization modes 120. The pre-defined optimization modes 118 may include a presentation mode in which the optimization controller 116 suppresses all of the user notifications 104 from the various data systems 102. For example, a user may be using the device to display a meeting presentation, such as on a tablet device or coupled to an external display device, and the user does not want any distractions, phone calls, or personal messages inadvertently displayed during the presentation. The pre-defined optimization modes 118 may also include a game mode or movie mode in which the optimization controller 116 suppresses the user notifications from the data systems while a game is being played, or while a movie is being displayed for viewing on the device, or on an external television display device. A device or component manufacturer may also include any other types of pre-defined optimization modes with the device.

The user-configured optimization modes 120 are configurable for user control to allow or suppress any one or combination of the user notifications 104 from the data systems. Unlike a work environment where a user may typically want to suppress all of the user notifications 104 from the data systems 102, such as during a meeting (e.g., the pre-defined presentation mode), a user may want to allow some of the user notifications in a social setting or home scenario. For example, a user may be streaming a movie from a mobile phone to an external television display device, yet still want to receive phone calls or be able to text message. The user may also configure an optimization mode that allows streaming media received via the device to be displayed on an external display device, and the optimization controller 116 suppresses display of the user notifications on the external display device, yet allows display of the user notifications on the integrated display device 108. Similarly, a user may want to share viewing of photos with others in a group and suppress text messages so that the others do not see the incoming text message displays.

In another scenario, a user may be attending an informal business meeting and, depending on the type of meeting, may want to suppress phone calls, but receive emails and instant messages, such as from someone that is running late to the meeting. In embodiments of device optimization modes, a user can customize and configure any type of optimization mode, suited to his or her specific needs and activities. For example, a user may configure a do-not-disturb optimization mode that the optimization controller 116 initiates for fifteen minutes (e.g., an x number of minutes or other duration of time). The do-not-disturb optimization mode can be customized so that the user will still receive important or high-priority messages, such as from his or her boss or spouse, yet suppress all of the other user notifications 104 from the data systems 102. After the fifteen minutes, or other time duration, the optimization controller can initiate a notification to inform the user that the optimization mode is ending. Optionally, the user may be provided with a selection choice to confirm ending the optimization mode, or to extend the do-not-disturb optimization mode. In another example, a user that participates in stock trading from a mobile phone device may want to optimize all of the available bandwidth use for a stock trading application, in effect suspending all other background data transfers (e.g., email sync) while the user is trading.

The optimization controller 116 can initiate a pre-defined or user-configured optimization mode, such as when an automated input is received from an activity system (e.g., any combination of components, devices, software, hardware, etc. that is the activity system 106 for a particular activity). For example, when a presentation application (e.g., a software application 114 of the activity system 106) is started for use, such as for a meeting presentation, the optimization controller 116 can initiate a presentation optimization mode (e.g., pre-defined or user-configured) that suppresses the user notifications 104 from the data systems 102 while the presentation application is in use on the device. Similarly, a specific application may prompt a user to select an optimization mode, such as a movie playback application that prompts the user to enter a movie mode (also either pre-defined or user-configured). A user may also select an optimization mode (e.g., pre-defined or user-configured) from a user interface menu, drop-down menu, or any other type of user-selectable control. The optimization controller can receive the user selection of an optimization mode as an input to initiate the selected optimization mode.

In embodiments, the optimization controller 116 is also implemented to initiate an optimization mode based on a pre-set time setting and/or time duration, based on a software application that is in use on the device, based on a location of the device, and/or based on a proximity of the device relative to other devices. The optimization controller may also initiate an optimization mode when triggered by geo-location or learned behavior, such as if a user repeatedly selects to ignore a phone call, the optimization controller can provide the user with an option to suppress all of the user notifications for a duration of time. In some examples, a user may configure a lunch optimization mode (e.g., a user-configured optimization mode 120) to suppress all of the user notifications 104 from the data systems 102 each weekday at noon for a time duration of one hour. A user may also configure a location optimization mode based on a location of the device, such as to suppress one or more of the user notifications 104 while in a building or particular work environment. In another example, a user may also configure a proximity optimization mode based on a proximity of the device relative to other devices, such as in proximity to the boss's mobile phone, or in a meeting in relative proximity to several other devices.

The optimization controller 116 is also implemented to end or cancel an optimization mode when an activity terminates, after a duration of time, based on a detected change of user environment or change in user state (e.g., when the user leaves a location), or when a user input is received to end the optimization mode. For example, the optimization controller can end the presentation optimization mode when the presentation application is closed after the meeting presentation, and resume the user notifications 104 from the data systems 102. In another example, the location optimization mode may be configured so that the optimization controller maintains the optimization mode until the device exits the location, and then the location optimization mode is ended or canceled to resume the user notifications.

In embodiments, the optimization controller 116 is implemented to initiate a battery level warning of an optimization mode to indicate a minimum level of battery power remaining to power the device over a duration of time, such as for the next hour, or for the remainder of the workday. The minimum level of battery power can be determined based on previous battery power used over similar durations of time. A user that plays games on a device in airplane mode on a long flight may want to be sure to save enough battery power to make several minutes of phone calls and get driving directions when getting off the plane at his or her destination. Most devices include a battery level warning to notify the user that battery power has been depleted and only a small percentage of power remains, such as just enough power to save a current work project and power-off the device.

In embodiments of device optimization modes, a user can configure a battery optimization mode (e.g., a user-configured optimization mode 120) that provides the user a warning or notification at any minimum level of battery power remaining. For example, a user may play video games or read on the device 100 as supported by the activity system 106, but also want to be notified when a minimum level of battery power remains to conserve the remaining battery power for the rest of the workday, or for other critical services, such as to be able to make phone calls and receive messages. This is a user-defined resource limit warning, rather than the typical shut-down warning after all but a small percentage of power remains. Further, the user-defined resource limit warning can be configured as a variable (rather than a specified percentage of power), such as to conserve two hours of battery power for normal device usage based on a typical usage pattern at that time of day.

In a similar example, an optimization mode can be configured to optimize the device 100 for a task or activity, such as for intensive high-definition video streaming. The optimization mode can be configured to turn-off or limit running background processes, such as to delay data transfers, limit an email application checking for new email messages, and the like. The optimization controller 116 can be implemented to monitor processing (e.g., CPU) and/or bandwidth resources and constraints, and initiate an optimization mode to limit the background tasks so that the device operates at an optimal performance for a particular task or activity.

In embodiments, the optimization controller 116 is also implemented to manage suppressed user notifications 122 when an optimization mode is ended or canceled, and can control an order and pace in which the suppressed user notifications are resumed. The optimization controller implements a smooth resumption of functionality without loss of data to resume the user notifications, and without overwhelming the user with all of the suppressed user notifications. In implementations, the suppressed user notifications 122 are queued, such as in persistent storage, to maintain the user notifications until they are resumed. Alternatively, the suppressed user notifications are tracked and invoked from the individual data systems 102 when the user notifications are resumed.

In implementations, the optimization controller 116 can initiate one audible tone of a particular format for multiple audible tones of the particular format that are suppressed in the optimization mode. For example, rather than allowing ten text message alerts in succession, the optimization controller can initiate one of the text message alerts to inform the user that one or more text messages were suppressed while in the optimization mode. Alternatively, the optimization controller 116 may include different optimization mode notifications 124, and the optimization controller can replace a collective of the suppressed user notifications with an optimization mode notification when the optimization mode is ended.

Additionally, the optimization controller 116 can generate a summary of the suppressed user notifications, such as a summary display from which the user can select the suppressed user notifications. Alternatively or in addition, the optimization controller can generate a quick time playback of the suppressed user notifications and/or organize the suppressed user notifications by time, priority, or a defined preference for user selection to review a selected notification. The optimization controller can also be implemented to control optimization responses 126 (e.g., a busy response), such as an automatic text back if a user of the device is driving and cannot text, or initiate playback of a different voice message if the user is in a meeting and cannot take a phone call.

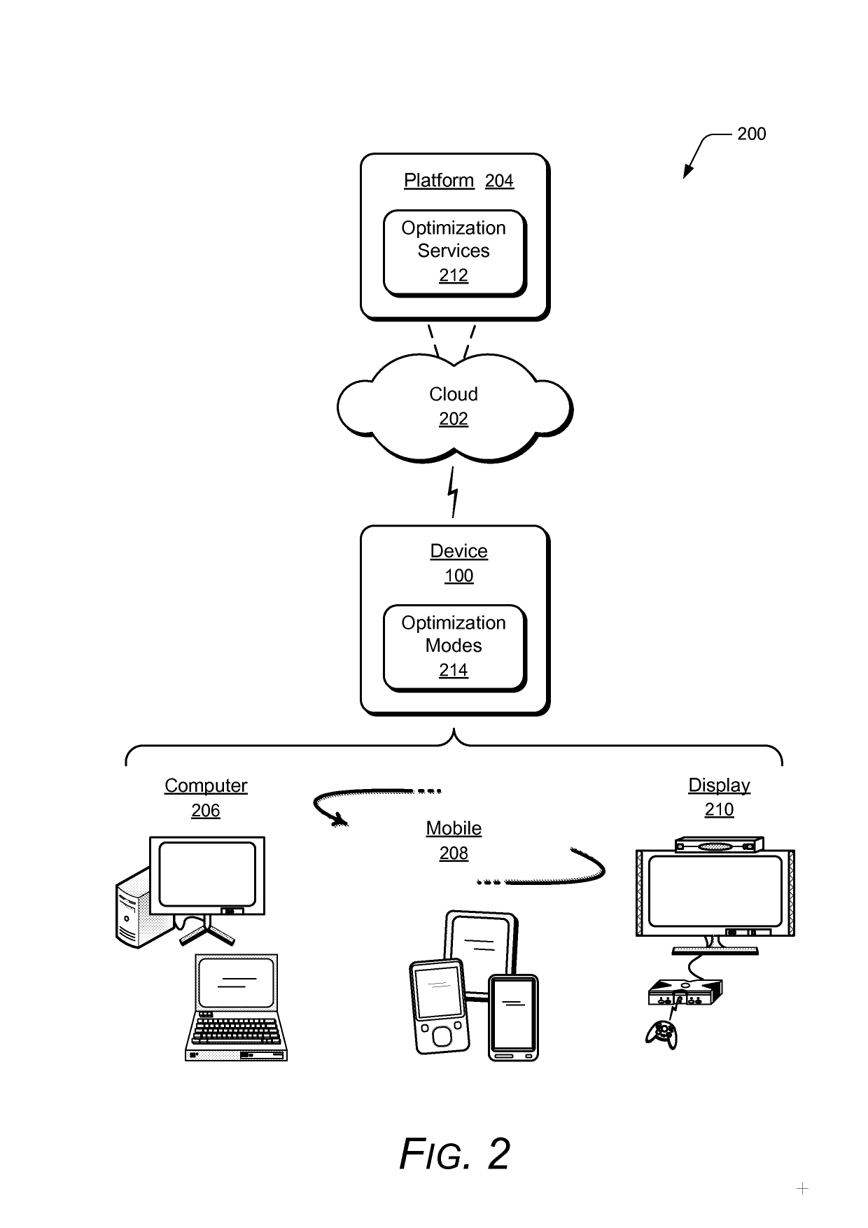

FIG. 2 illustrates an example system 200 that includes the device 100 as described with reference to FIG. 1. The example system 200 enables ubiquitous environments for a seamless user experience on any type of user device, such as a computing device, display device, and/or mobile device. Services and applications run substantially similar in all of the environments for a common user experience, such as when transitioning from one device to the next while utilizing an application, playing a video game, watching a video, listening to music, and so on.

In the example system 200, multiple devices can be interconnected through a central computing device or system, which may be local to the multiple devices or may be located remotely from the multiple devices. In one embodiment, the central computing device may be a cloud 202 of one or more server computers that are connected to the multiple devices through a network, the Internet, or other data communication link. In embodiments, this interconnection architecture enables functionality across multiple devices to provide a common and seamless experience to a user of the multiple devices. Each of the devices may have different physical configurations and capabilities, and the central computing device can utilize a platform 204 to enable delivery of an experience that is tailored to a particular device and/or common to all of the devices.

In various implementations, the device 100 may be implemented in a variety of different configurations, such as for computing 206, mobile 208, and display 210 uses. Each of these configurations includes devices that may have generally different constructs and capabilities, and the device 100 may be configured as one or more of the different devices. For example, the device may be implemented as any type of a computer, laptop, tablet, netbook, and so on. The device 100 may also be implemented as any type of mobile device, such as a mobile phone, portable media device, a tablet device, and so on. The device may also be implemented as any type of television and/or display device having or connected to generally larger display screens in casual viewing environments. These devices include televisions, set-top boxes, gaming consoles, and so on. The techniques described herein may be supported by these various configurations of the device and are not limited to the specific examples of the embodiments described herein.

The cloud 202 includes and/or is representative of the platform 204 for optimization services 212. The platform abstracts underlying functionality of hardware, such as server devices, and/or software resources of the cloud. The optimization services may include applications and/or data that can be utilized while computer processing is executed on servers that are remote from the device 100. For example, the optimization services 212 may include an implementation of the optimization controller 116 as described with reference to FIG. 1 to implement embodiments of device optimization modes. For example, the optimization services 212 can be implemented to maintain incoming messages and/or the user notifications in the cloud. The messages and user notifications are then communicated to the device when the device is not operating under the parameters of one or more of the optimization modes 214 (e.g., the pre-defined optimization modes 118 and/or the user-configured optimization modes 120). This enables the device 100 to optimize data, bandwidth, battery power use, and other processing resources with the user notifications and other interruptions maintained in the cloud.

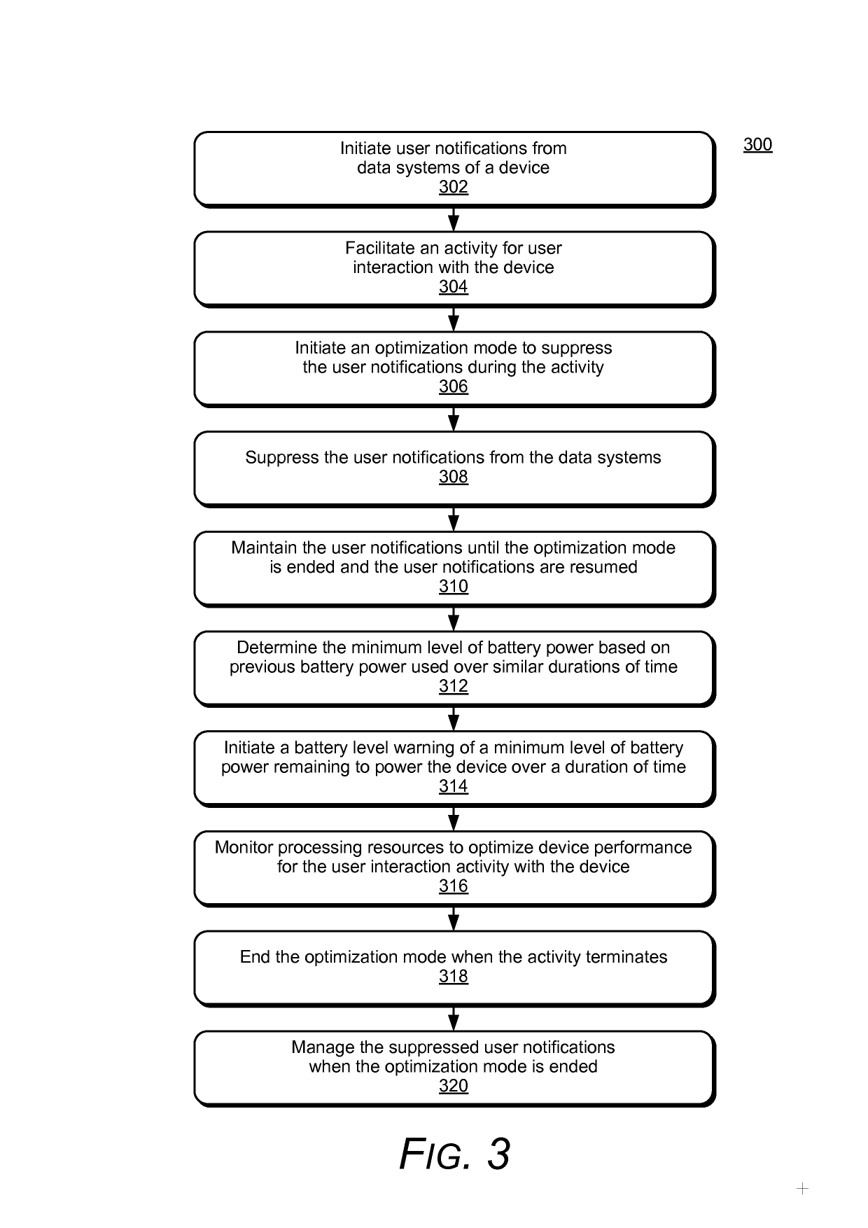

Example method 300 is described with reference to FIG. 3 in accordance with one or more embodiments of device optimization modes. Generally, any of the services, functions, methods, procedures, components, and modules described herein can be implemented using software, firmware, hardware (e.g., fixed logic circuitry), manual processing, or any combination thereof. A software implementation represents program code that performs specified tasks when executed by a computer processor. The example methods may be described in the general context of computer-executable instructions, which can include software, applications, routines, programs, objects, components, data structures, procedures, modules, functions, and the like. The program code can be stored in one or more computer-readable storage media devices, both local and/or remote to a computer processor. The methods may also be practiced in a distributed computing environment by multiple computer devices. Further, the features described herein are platform-independent and can be implemented on a variety of computing platforms having a variety of processors.

FIG. 3 illustrates example method(s) 300 of device optimization modes. The order in which the method blocks are described are not intended to be construed as a limitation, and any number of the described method blocks can be combined in any order to implement a method, or an alternate method.

At block 302, user notifications are initiated from data systems of a device. For example, the various data systems 102 of the device 100 (FIG. 1) initiate the user notifications 104. For example, a wireless controller indicates the availability of a network connection as a pop-up display. Similarly, an email application, text messaging application, or instant messaging application initiates an audible alert tone and/or displays a notification of a new email message, text message, or instant message. A calendar application initiates an audible alert tone and/or displays a notification of a calendar event, reminder, and/or to-do notification. Similarly, a geo-location application initiates a geo-location alert. A gaming application initiates a notification display to inform a user it is his or her turn to play. A battery monitor application initiates an audible alert tone and/or display a battery level warning notification. When implemented as a mobile phone, the data systems 102 of the device 100 can include a communication device that rings to notify a user of an incoming phone call.

At block 304, an activity is facilitated for user interaction with the device. For example, the activity system 106 of the device 100 facilitates any type of activities for user interaction with the device, such as watching a movie, viewing photo images, playing a video game, browsing Internet sites, or other types of active and/or passive user interaction activities. The activity system 106 includes any combination of components, devices, software, hardware, etc. that is the activity system for a particular activity of user interaction on or with the device.

At block 306, an optimization mode is initiated to suppress the user notifications during the activity. For example, the optimization controller 116 of the device 100 initiates a pre-defined, selectable optimization mode 118 or a user-configured, selectable optimization mode 120. The optimization mode can be initiated based on a pre-set time setting and/or time duration, based on a software application that is in use on the device, a location of the device, and/or a proximity of the device relative to another device. The optimization controller 116 may also initiate an optimization mode when triggered by geo-location or learned behavior, such as if a user repeatedly selects to ignore a phone call, the optimization controller can provide the user with an option to suppress all of the user notifications for a duration of time.

At block 308, the user notifications from the data systems are suppressed. For example, the optimization controller 116 of the device 100 suppresses the user notifications 104 from the data systems 102, which may be suppressed based on parameters and/or a configuration of the optimization mode, such as based on the function and/or features of an application, or based on a time duration, a location of the device, a proximity of the device relative to other devices, and/or based on user configuration. At block 310, the user notifications are maintained until the optimization mode is ended and the user notifications are resumed. For example, the suppressed user notifications 122 are maintained, such as in persistent storage, or are tracked and invoked from the individual data systems 102 when the user notifications are resumed. Alternatively, the suppressed user notifications may be maintained by the optimization services 212 (FIG. 2) in a cloud-based implementation of device optimization modes.

At block 312, a minimum level of battery power is determined based on previous battery power used over durations of time. For example, the optimization controller 116 of the device 100 determines a minimum level of battery power based on previous battery power used over similar durations of time, such as for the next hour, or for the remainder of the workday, so that a user can conserve the remaining power. At block 314, a battery level warning of the optimization mode is initiated to indicate a minimum level of battery power remaining to power the device over a duration of time. For example, the optimization controller 116 of the device 100 initiates a battery level warning of an optimization mode to indicate the minimum level of battery power remaining to power the device over the duration of time.

At block 316, processing resources are monitored to optimize device performance for the user interaction activity with the device. For example, the optimization controller 116 of the device 100 monitors the processing resources, such as CPU and/or bandwidth resources and constraints, and initiates an optimization mode to limit the background tasks so that the device operates at an optimal performance for a particular task or activity (e.g., the facilitated activity at block 304).

At block 318, the optimization mode is ended when the activity terminates. For example, the optimization controller 116 of the device 100 ends or cancels an optimization mode when an activity terminates (e.g., based on an input from the activity system 106), after a duration of time, based on a detected change of user environment or change in user state (e.g., when the user leaves a location), or when a user input is received to end the optimization mode.

At block 320, the suppressed user notifications are managed when the optimization mode is ended. For example, the optimization controller 116 of the device 100 manages the suppressed user notifications 122 when an optimization mode is ended or canceled, and controls the order and pace in which the suppressed user notifications are resumed. In embodiments, the optimization controller initiates one audible tone of a particular format for multiple audible tones of the particular format that are suppressed in the optimization mode and/or replaces a collective of the suppressed user notifications with an optimization mode notification when the optimization mode is ended. Alternatively or in addition, the optimization controller generates a summary of the suppressed user notifications, generates a quick time playback of the suppressed user notifications, and/or organizes the suppressed user notifications by time, priority, or a defined preference for user selection.

FIG. 4 illustrates various components of an example device 400 that can be implemented as any of the devices described with reference to the previous FIGS. 1-3, such as any type of client device, mobile phone, tablet device, computing, consumer, communication, entertainment, gaming, navigation, media playback, and/or other type of device. The device may also be associated with a user (i.e., a person) and/or an entity that operates the device such that a device describes logical devices that include users, software, firmware, hardware, and/or a combination of devices.

The device 400 includes communication devices 402 that enable wired and/or wireless communication of device data 404, such as the suppressed user notifications, configuration settings of the device, media content stored on the device, and/or information associated with a user of the device. The media content stored on the device can include any type of audio, video, and/or image data. The device includes one or more data inputs 406 via which any type of data, media content, and/or inputs can be received, such as user-selectable inputs and any other type of audio, video, and/or image data received from any content and/or data source. The data inputs 406 may include USB ports, coaxial cable, and other serial or parallel connectors (including internal connectors) for flash memory, DVDs, CDs, and the like. The data inputs can be used to couple the device to components, peripherals, and accessories, such as keyboards, microphones, cameras, and any other type of devices.

The device 400 also includes communication interfaces 408, such as any one or more of a serial, parallel, network, or wireless interface. The communication interfaces provide a connection and/or communication links between the device and a communication network by which other electronic, computing, and communication devices communicate data with the device. Although not shown, the device can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

The device 400 includes one or more processors 410 (e.g., any of microprocessors, controllers, and the like) or a processor and memory system (e.g., implemented in an SoC), which processes computer-executable instructions to control the operation of the device. Alternatively or in addition, the device can be implemented with any one or combination of software, hardware, firmware, or fixed logic circuitry that is implemented in connection with processing and control circuits which are generally identified at 412.

The device 400 also includes one or more memory devices 414 (e.g., computer-readable storage media) that enable data storage, such as random access memory (RAM), non-volatile memory (e.g., read-only memory (ROM), flash memory, etc.), and a disk storage device. A disk storage device may be implemented as any type of magnetic or optical storage device, such as a hard disk drive, a recordable and/or rewriteable disc, and the like. The device may also include a mass storage media device. Computer-readable storage media can be any available medium or media that is accessed by a computing device.

A memory device 414 provides data storage mechanisms to store the device data 404, other types of information and/or data, and device applications 416. For example, an operating system 418 can be maintained as a software application with the memory device and executed on the processors. The device applications may also include a device manager or controller, such as any form of a control application, software application, signal processing and control module, code that is native to a particular device, a hardware abstraction layer for a particular device, and so on. In this example, the device applications also include an optimization controller 420 that implements embodiments of device optimization modes. An example of the optimization controller 420 is the optimization controller 116 of the device 100, as shown and described with reference to FIGS. 1 and 2. Although shown implemented as a software application, the optimization controller 420 may be implemented in the general context of software, firmware, hardware (e.g., fixed logic circuitry), or any combination thereof.

The device 400 may also include an audio and/or video processing system 422 that generates audio data for an audio system 424 and/or generates display data for a display system 426. The audio system and/or the display system may include any devices that process, display, and/or otherwise render audio, video, display, and/or image data. In implementations, the audio system and/or the display system are external components to the device. Alternatively, the audio system and/or the display system are integrated components of the example device.

Although embodiments of device optimization modes have been described in language specific to features and/or methods, the appended claims are not necessarily limited to the specific features or methods described. Rather, the specific features and methods are disclosed as example implementations of device optimization modes.

1. A device, comprising:
one or more data systems configured to initiate user notifications;
an activity system configured to facilitate an activity for user interaction;
a memory and processor system to implement an optimization controller that is configured to:
initiate an optimization mode to suppress the user notifications during the activity;
suppress the user notifications from the one or more data systems; and
maintain the user notifications until the optimization mode is ended and the user notifications are resumed.

2. A device as recited in claim 1, wherein the optimization mode is one of:
a pre-defined optimization mode; or
a user-configured optimization mode.

3. A device as recited in claim 1, wherein the optimization controller is configured to receive an automated input from the activity system to initiate the optimization mode, and wherein the optimization controller is further configured to end the optimization mode when the activity terminates.

4. A device as recited in claim 1, wherein the optimization controller is configured to receive a user input to initiate the optimization mode.

5. A device as recited in claim 1, wherein the optimization controller is configured to initiate the optimization mode based on at least one of:
a pre-set time setting;
a software application that is in use on the device;
a location of the device; and
a proximity of the device relative to another device.

6. A device as recited in claim 1, wherein the optimization controller is further configured to end the optimization mode based on a user input, after a duration of time, or based on a detected change of user environment.

7. A device as recited in claim 1, wherein the optimization controller is configured to manage resumption of the suppressed user notifications when the optimization mode is ended.

8. A device as recited in claim 7, wherein the optimization controller is configured to initiate one audible tone of a particular format for multiple audible tones of the particular format that are suppressed in the optimization mode.

9. A device as recited in claim 7, wherein the optimization controller is configured to control an order and pace in which the suppressed user notifications are resumed.

10. A device as recited in claim 7, wherein the optimization controller is configured to replace a collective of the suppressed user notifications with an optimization mode notification when the optimization mode is ended.

11. A device as recited in claim 7, wherein the controller is configured to one of:
generate a summary of the suppressed user notifications;
generate a quick time playback of the suppressed user notifications; or
organize the suppressed user notifications by time, priority, or a defined preference for user selection.

12. A device as recited in claim 1, wherein the optimization controller is configured to initiate a battery level warning of the optimization mode to indicate a minimum level of battery power remaining to power the device over a duration of time.

13. A device as recited in claim 12, wherein the minimum level of battery power is determined based on an average of previous battery power used over similar durations of time.

14. A device as recited in claim 1, wherein the activity system includes at least an integrated display device of the device and an external display device coupled to the device, the external display device configured to display streaming media received via the device, and the optimization mode configured to suppress display of the user notifications on the external display device and allow display of the user notifications on the integrated display device.

15. A method, comprising:
initiating user notifications from one or more data systems of a device;
facilitating an activity for user interaction with the device;
initiating an optimization mode to suppress the user notifications during the activity;
suppressing the user notifications from the one or more data systems; and
maintaining the user notifications until the optimization mode is ended and the user notifications are resumed.

16. A method as recited in claim 15, further comprising:
receiving an automated input from an activity system to initiate the optimization mode; and
ending the optimization mode when the activity terminates.

17. A method as recited in claim 15, further comprising initiating the optimization mode based on at least one of:
a pre-set time setting;
a software application that is in use on the device;
a location of the device; and
a proximity of the device relative to another device.

18. A method as recited in claim 15, further comprising managing the suppressed user notifications when the optimization mode is ended.

19. A method, comprising:
initiating user notifications from one or more data systems of a device;
facilitating an activity for user interaction with the device;
initiating an optimization mode to suppress the user notifications from the one or more data systems during the activity; and
initiating a battery level warning of the optimization mode to indicate a minimum level of battery power remaining to power the device over a duration of time.

20. A method as recited in claim 19, further comprising determining the minimum level of battery power based on an average of previous battery power used over similar durations of time.
